(19) United States
(12) Patent Application Publication
(10) Pub. No.: US 2007/0151567 A1
(43) Pub. Date: Jul. 5, 2007

(54) Easy breathing mouthguard

(76) Inventor: John Maurello, Oceanside, NY (US)

Correspondence Address: LAW OFFICE OF LEO G. LENNA, 1 MAKAMAH BEACH ROAD, NORTHPORT, NY, 11768, US

(21) Appl. No.: 11/325,260

(22) Filed: Jan. 5, 2006

(51) Int. Cl. A61C 5/14

(52) U.S. Cl. 128/859

(57) ABSTRACT

The present application is directed to a mouth guard having upper and lower portions hinged together by at least a portion of the back portion of the mouth guard. The mouth guard is designed to have a substantial open area between the upper and lower portions for easy breathing. The mouth guard may also have cilia in the cavity that comes in contact with the user's teeth to assure a proper fit each time it is used. The mouth guard may also contain flavoring such as Gatorade, bubble gum flavoring, as well as the traditional cherry, orange and grape that can be released into the oral cavity of the user while wearing the mouth guard. This allows the user to taste the flavoring while using the mouth guard.

### FIELD OF THE INVENTION

The present invention relates to a mouth guard for use by an athlete while participating in contact sports such as football, hockey, and lacrosse, which may be used alone or in combination with a protective helmet or protective headgear. In particular, the present invention relates to a mouth guard having upper and lower portions hinged together by at least a portion of the upper and lower sections. The mouth guard is designed to have a substantial open area between the upper and lower portions for easy breathing.

### BACKGROUND OF THE INVENTION

Participation in athletic activities is increasing at all age levels. All participants may be potentially exposed to physical harm as a result such participation. Physical harm is more likely to occur in athletic events were collisions between participants frequently occurs such as football, field hockey, lacrosse, ice hockey, soccer and the like. In connection with sports such as football, hockey and lacrosse where deliberate collisions between participants are common, the potential for physical harm and/or injury is greatly enhanced. Facial trauma experienced by athletes has been demonstrably reduced by the use of a mouth guard during participation in athletic events. These mouth guards, or mouth protectors, provide protection against injuries to the teeth, lips, cheeks, and gums, and may also reduce the incidence of head and neck injuries, concussions, and jaw fractures.

The use of mouth guards is well known. In fact the American Society for Testing and Materials has classified mouth guards into three types: stock mouth guards, mouth-formed mouth guards, and custom-fabricated mouth guards. Some of these mouth guards are fitted with a tether or strap to connect them to a fastening point, such as a helmet or the like, to prevent loss, swallowing or choking on the mouth guard by the user.

Stock mouth guards typically can be purchased at sporting goods stores, department stores and/or pharmacies. These mouth guards may be made of rubber, polyvinyl chloride, or polyvinyl acetate copolymer and are typically available in small, medium, and large sizes. These stock mouth guards are not in any way molded or “fit” to the persons wearing them and, as a result, can be loose and uncomfortable for the user. Often the mouth must be closed in order to hold them in place, and, not surprisingly, many athletes find them bulky and uncomfortable. In addition, these mouth guards can interfere with speech and breathing, which is a further strong disincentive for athletes to wear these mouth guards. The one benefit to these mouth guards is that they are inexpensive.

Mouth-formed mouth guards are fitted by the user. They are molded to fit the individual wearer either by the use of a moldable inner liner typically of plasticized acrylic gel or silicone rubber, or the use of a moldable thermoplastic that softens when immersed in boiling water and sets when cooled. The thermoplastic mouth guard is also known as the “boil-and-bite” mouth guard. However, repeated biting during participation in athletic events or gnawing due to nervousness before or during an athletic event can cause the material to spread resulting in a loose fit. In addition, aging and/or continual exposure to oral fluids may cause the plasticizers to leach out causing the liner to become hard.

Custom-made mouth guards are considered to be the best of the conventional mouth guards as far as fit, shape retention and comfort are concerned, but they are also the most expensive. This type of mouth guard tends to not have the bulk of the other two types and may stay in position better. Custom mouth guards are typically composed of a thermoplastic polymer, of which the most popular type is ethylene/vinyl acetate copolymer, although acrylic resin, polyurethane, and various rubber materials are also used. Custom-made mouth guards are fabricated by molding over a cast of a person's dentition, and most often this process is done by a dentist or in a dental laboratory. There are usually four steps required in the making of a custom-fit mouth guard: 1) making an impression of the maxillary arch; 2) pouring a cast; 3) forming the thermoplastic material on the cast; and 4) finishing the protector.

Since 1950 the American Dental Association (ADA) has been active in promoting the use of mouth protectors. In addition to preventing injuries to the teeth, gums, and facial area, a properly fitted mouth guard is believed to be responsible for reducing the number of concussions and neck injuries suffered by athletes. One study by the ADA using a cadaver showed that a mouth protector reduced the amplitude of the inter-cranial pressure wave and decreased the amount of bone deformation by as much as 50%.

Recent improvements in mouth guard performance relate to improved energy absorption. For example, U.S. Pat. No. 5,339,832, to Kittelsen et al., is directed to a thermoplastic mouth guard with an integral shock absorbing framework. The composite mouth guard of Kittelsen et al. comprises a U-shaped mouth guard portion made of a softenable thermoplastic and a shock absorbing and attenuating low compression elastomer framework embedded in the U-shaped mouth guard portion. The shock-absorbing insert portion of the mouth guard attenuates and dissipates shock forces exerted on the mouth guard during athletic activity. This is necessary to protect the teeth of the athlete.

While playing sports the exchange of oxygen and carbon dioxide is crucial for strength and well being. The exchange of oxygen and carbon dioxide happens in the lungs but one of the rate of exchange is directly related to the rate in which oxygen is brought into the body and carbon dioxide is released. Oxygen is brought into the lungs by the nasal passages as well as the mouth. The more carbon dioxide that accumulates in the muscles, the faster the carbon dioxide has to be exchanged in the lungs with oxygen. Since more carbon dioxide is produced during athletic activities, both the nasal passages and the oral passage are used to get fresh oxygen into the lungs and exhale carbon dioxide.

Having a solid mouth guard, like the conventional mouth guards, does not allow the easy passage of air into the oral cavity and therefore limits the exchange of carbon dioxide with oxygen in the lungs. This at a time where it is needed most. To composite for this some athletes use special nose pieces to open the nasal passages to increase air exchange since the oral cavity is obstructed by the conventional one piece mouth guards. This method helps air flow into the lungs by the nasal passageway by increasing the size of the passageway for air flow. However, this does not provide nearly enough air flow to exhale the carbon dioxide produced during aerobic sports.

Therefore what is needed is a mouth guard that protects the teeth but allows the full passage of air in and out the oral cavity when needed most.

The present invention relates to a mouth guard that protects the teeth but leaves the center of the mouth guard open for air exchange through the oral cavity. Opening up the oral passage for air exchange while protecting the teeth allows an athlete to increase air flow in and out of the body so as to reduce the amount of carbon dioxide build-up in the body. Excess carbon dioxide build-up in the muscles can lead to fatigue and cramps, two conditions that limit the athlete's capabilities.

The mouth guard may also have raised cilia in the cavity designed to accept the teeth that can be manipulated by the teeth once worn to make the mouth guard fit properly. In addition, the present invention relates to a mouth guard having a flavor impregnated within either as flavor crystals or as a separate flavor pouch so as to allow the user to taste a particular flavor when released. The

As will become apparent from the following description, the present invention is a novel, cold formable mouth guard that allows the user to fit the mouth piece by depressing cilia that extend upwardly in the canal where the teeth are to be placed and has a substantial opening between the upper and lower portions so as to allow easy air flow in the oral cavity.

The present invention addresses the shortcomings of the mouth guards available on the market today as well as providing additional benefits.

### SUMMARY OF THE INVENTION

The present invention is directed to a mouth guard for protecting teeth that comprises an upper unshaped portion that hugs closely to the upper teeth and a lower unshaped portion that hugs closely to the bottom teeth. The upper and lower portions are connected together by a hinged section located in the rear of each side of the mouth guard. This formation provides for a substantial opening between the upper and lower portions so as to allow free air passage in and out of the oral cavity.

In one embodiment of the invention, the mouth guard may comprise a flavoring material. The flavoring material may be impregnated throughout the material from which the mouth guard is constructed in the form of flavor crystals. In the alternative the mouth guard of the invention may be equipped with at least one pocket formed in at least one of the inner walls, outer walls or the base of the channel of the mouth guard. The pocket may be sized and shaped to receive a flavoring agent capsule.

At least one duct extends from the flavor pocket to an inner surface of the mouth guard whereby defining a passageway in which the flavoring agent can flow into the oral cavity of the user. The flavor capsule can either be made of a saliva dissolving material such as starch so that the capsule dissolves after extended contact with the saliva of the user. Once the capsule wall dissolves, the flavor releases into the oral cavity of the user.

In the alternative, the flavor capsule can be released from the flavor capsule when sufficient force is placed on the flavor containing capsule by the user. So that the mouth guard can be used over and over again with a fresh taste each time, the mouth guard may further comprise an opening formed in the flavor pockets. This opening formed in the flavor pockets provides a passageway for the flavoring agent capsule to be replaced.

In still another embodiment of the invention, the mouth guard comprises a first U-shaped structure having an inner wall and outer wall. The inner and outer walls of the mouth guard are connected to each other by a base forming a channel between the walls. The channel of the mouth guard is designed to fit the upper teeth of a user. The mouth guard also has a second U-shaped structure having inner walls and outer walls connected to each other by a base forming a channel between the walls. This channel is designed for the lower teeth of a user. The upper U-shaped portion and the lower U-shaped portion are connected by a hinge means at the back of each of the ends of the u shape. This creates a single unit system with a substantial opening in the center for easy air passage.

Dispersed in the channel of the U-shaped structures of the mouth guard is a plurality of flexible extensions, referred to as cilia, that project away from the base within the channel of the mouth guard. In other words, the cilia will project downwardly form the base of the U-shaped structure designed to protect the upper teeth of the user and upwardly from the base of the U-shaped structure designed to protect the lower portion of the user's teeth. Simply stated the cilia are always projecting towards the teeth of the user.

The cilia are constructed of an elastomeric material that is formable to the dentition of a wearer at room temperature. In other wards, when the mouth guard is placed into the mouth of the user, the cilia are either depressed or moved to the side of the teeth so as to allow the mouth guard to fit tightly into the user's mouth.

The mouth guard having an upper and lower protective portion is connected together by hinge portions located at the back of each side of the mouth guard. As stated above, this design provides a substantial air passageway between the upper and the lower portions of the mouth guard. When placed on the upper and lower dentures of the user, the tongue is isolated from the teeth so as not to be bruised if the user is hit in the facial area. This design is more comfortable than the one piece mouth guard on the market today and allows much more air to pass in and out of the oral cavity of the user. This allows the athlete using the mouth guard of the instant invention to breath easier when running or exerting themselves while using the mouth guard.

As with the embodiments described above, this embodiment of the invention can be equipped with at least one pocket formed in at least one of the inner walls, outer walls or the base of the channel of the mouth guard. The pocket may be sized and shaped to receive a flavoring agent capsule. At least one duct extends from the flavor pocket to an inner surface of the mouth guard whereby defining a passageway in which the flavoring agent can flow into the oral cavity of the user.

The flavor capsule can either be made of a saliva dissolving material such as starch so that the capsule dissolves after extended contact with the saliva of the user. Once the capsule wall dissolves, the flavor releases into the oral cavity of the user.

In the alternative, the flavor capsule can be released from the flavor capsule when sufficient force is placed on the flavor containing capsule by the user. So that the mouth guard can be used over and over again with a fresh taste each time, the mouth guard may further comprise an opening formed in the flavor pockets. This opening formed in the flavor pockets provides a passageway for the flavoring agent capsule to be replaced.

The flavoring may be selected from the group consisting of mint flavoring, sweet flavoring, vanilla flavoring, bubblegum flavoring, sour flavoring, electrolyte containing flavoring, caffeine containing flavoring and cola flavoring. The embodiments of the invention overcome the problems in the prior art and are more completely described using the figures in the detailed description of the invention.

The present invention is shown in the figures and described more fully in the detailed description of the figures below.

### BRIEF DESCRIPTION OF THE FIGURES

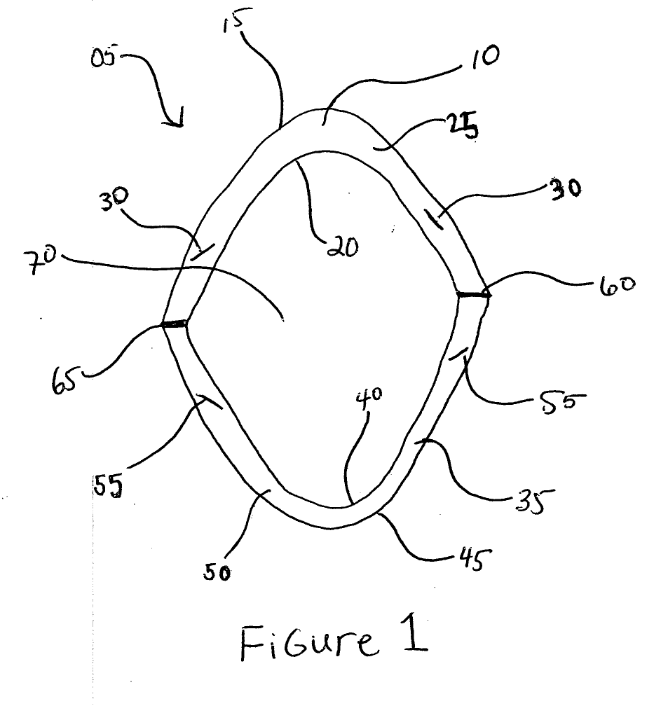

FIG. 1: TOP VIEW OF OPEN MOUTH GUARD
(05) mouth guard
(10) upper portion of mouth guard
(15) outer wall
(20) inner wall
(25) base
(30) flavor pocket
(35) lower portion of mouth guard
(40) inner wall
(45) outer wall
(50) base
(55) flavor pocket
(60) left hinge
(65) right hinge
(70) open oral cavity passage

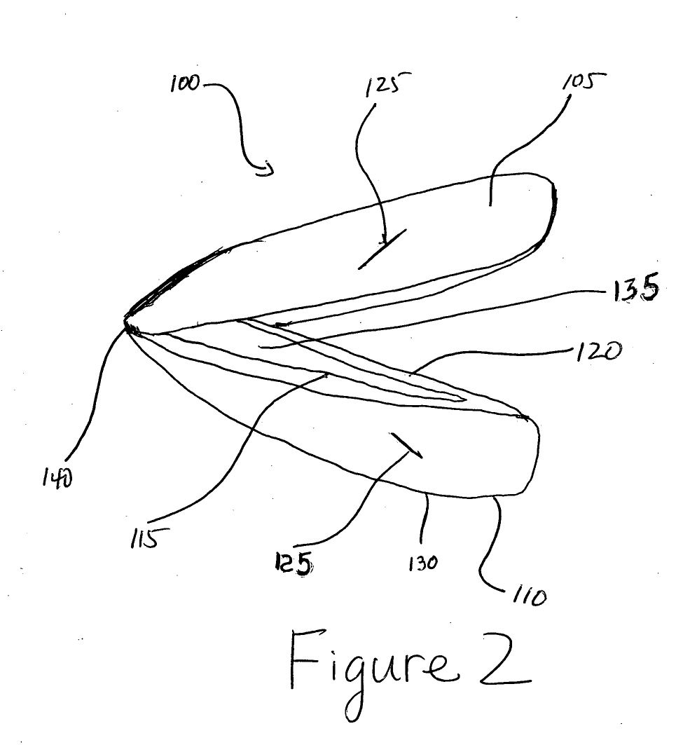

FIG. 2: Side View of Upper and Lower Mouth guard.
(100) Upper and Lower mouth guard
(105) upper portion of U-shaped mouth guard
(110) lower portion of U-shaped mouth guard
(115) inner wall of lower portion of U-shaped mouth guard
(120) outer wall
(125) flavor pocket
(130) base
(135) open oral cavity passage
(140) hinge portion

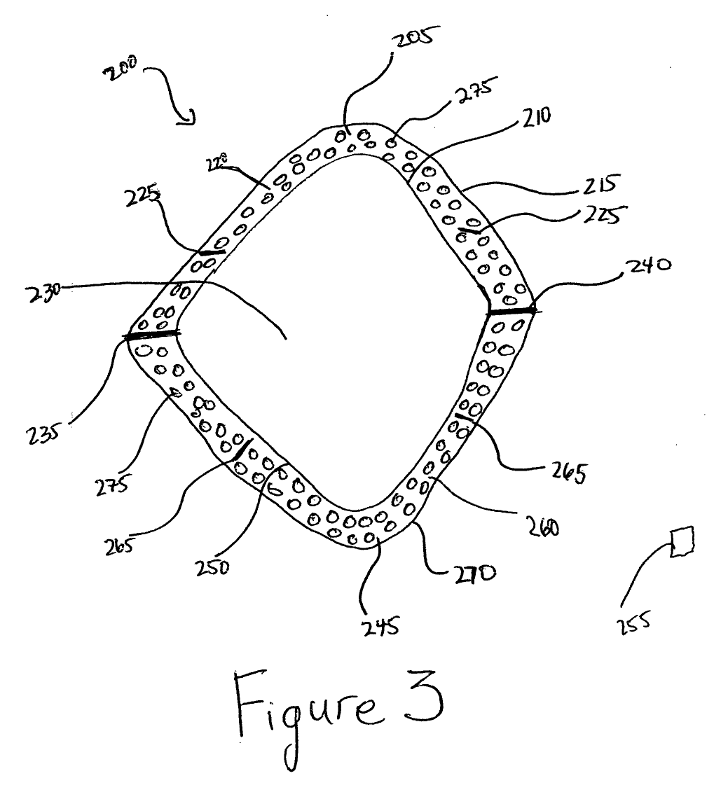

FIG. 3: TOP VIEW OF OPEN MOUTH GUARD WITH CILIA
(200) Top view of mouth guard with cilia
(205) upper portion of mouth guard
(210) inner wall
(215) outer wall
(220) base
(225) flavor pocket
(230) open oral cavity passage
(235) left hinge means
(240) right hinge means
(245) lower portion of mouth guard
(250) inner wall
(255) flavor capsule for flavor pocket
(260) base
(265) flavor pocket
(270) outer wall
(275) cilia

### DETAILED DESCRIPTION OF THE INVENTION

The invention described herein is directed to a mouth guard for protecting the teeth of the user while providing a substantial oral cavity for the passage of air so as to make it more comfortable for the user. The mouth guard is designed so as to fit tightly into the mouth of the user with or without using any forming techniques to form the mouthpiece to the user's teeth. There are two main embodiments of the invention that are depicted in FIGS. 1-3. One embodiment is directed to upper and lower U-shaped portions designed to closely hug the upper and lower dentures connected together by a right hinge means and a left hinge means located at the apex of the lower and upper u-shaped portions. In other words, the two U-shaped sections are connected together where the two points of the U-shaped portions come together to create a single unit having a substantial space between the portions so as to provide a tongue resting place and air to pass in and out of the oral cavity.

The mouth guard shown in FIG. 1 is in the open position so as to show how it would look prior to insertion into the oral cavity of the user. As can be seen form this view the mouth guard resembles what a pair of dentures would look like when placed in the same position. This is what the mouth guard of the instant invention is designed to behavior and feel like when used. In other words, unlike conventional mouth guards that are usually one solid piece, the mouth guard of the present invention is designed to hug the formation of the dentures so as not to hinder the passage of air in and out of the oral cavity, while providing protection to the lower and upper dentures. This design is much more comfortable than the one piece solid design of the prior art.

As shown in FIG. 1, the mouth guard of the instant invention (05) has an upper portion (10) that has an outer wall (15) and an inner wall (20) that is connected together by a base (25). The outer wall (15) is high enough to protect the front teeth of the user, yet low enough not to irritate the gums of the user. The inner wall (20) may be lower than the outer wall (15) so that the user's tongue can comfortably rest behind the inner wall (20). The outer and inner walls can be sloped so as to be higher in towards the front of the teeth and slope downward towards the back of the mouth guard.

In one embodiment of the invention, the upper portion (10) may have at least one pouch or pocket for placing a flavor containing pouch/capsule in so as to provide flavor to the oral cavity. In FIG. 1, the flavor pouches are shown as slits in the base (25) of the upper portion of the mouth guard (10). In the alternative, these flavor pouches (30) can be located in the inner wall (20) of the upper portion of the mouth guard (10) instead of the base (25). In still another embodiment of the invention, the flavor pockets (30) can be positioned in the outer wall (15) of the upper portion of the mouth guard making it easy for the user to insert a new capsule. If this is where the flavor pocket is located then the upper portion is equipped with a flavor passages (not shown) which can be as simple as a opening in the inner wall (20) of the mouth guard or can include accurate channels that extend between the flavor pocket and the outer surface of the upper portion of the mouth guard to the inner wall (20) so as to allow the flavor to flow from the flavor pocket to the oral cavity once the flavor capsule is ruptured.

The flavor passages can be slightly accurate or arched so as to form a vertical incline which will regulate the flow of gel flowing from the flavor capsule contained in the flavor pocket (30) through the arched channels and into the mouth of the user. Having this incline the user is able to take advantage of the flavor through an extended period of time over the course of a game and/or practice, rather than having the flavor from the capsules flow into his mouth quite readily and the taste be experienced only for a short time.

The flavor pocket may be fitted with an upper opening or slit in the rubberized material of the mouth guard which makes up the mouthpiece. The slit may be a flexible slit and would allow the user to slide the flavor gel capsule through the slit and into the flavor pocket. Once in place, the slit would then return back to its closed position, and therefore, would prevent the capsule from sliding out of the pocket inadvertently. This is important so as to prevent a choking hazard should the flavor capsule become dislodged due to blunt trauma.

The flavor containing capsule may contain either a gel or a flavored fluid and has a thin skin so that it can easily burst when pressure is applied thereupon. Once the flavor capsule is inserted into the mouth guard and the mouth guard is in place, and pressure is applied either through the use of the tongue or by biting down, flavor is released into the oral cavity of the user.

In still another embodiment of the invention, the walls of the flavor capsule can be made of a salvia-dissolvable material designed so that when the pouch comes in contact with saliva for extended period of time, the walls dissolve away and the flavor is released into the oral cavity of the user. No external pressure is needed to rupture this type of capsule. This type of capsule can thought of as a time release flavor system that is dependent on the chemical decay of the flavor pouch when in contact with saliva of the user. The pouch may be made of a starch based component that can be dissolved by amylase, an enzyme present in the saliva of most humans which chemical degrades starch into smaller it's smaller subunits of glucose, and sucrose.

FIG. 1 also shows a lower portion of the mouth guard having the same features and parts as the upper portion. Namely, the lower portion (35) has an outer wall (45) and an inner wall (40) that is connected together by a base (50). The outer wall (45) is high enough to protect the front teeth of the user, yet low enough not to irritate the gums of the user. The inner wall (40) may be lower than the outer wall (45) so that the user's tongue can comfortably rest behind the inner wall (40). The outer (45) and inner walls (40) can be sloped so as to be higher in towards the front of the teeth and slope downward towards the back of the mouth guard (05).

Both the upper portion (10) and the lower portion (35) are attached together at a right hinge means (60) and left hinge means (65) located at each side of the mouth guard. The hinge means (60, 65) are positioned in the rear of the mouth guard and connect the upper and the lower portion at the two points of each of the U-shaped portion to make a single unit. The single unit follows closely the dentures of the user and leaves a substantial breathing space from the exchange of air in the oral cavity.

The hinge means can be made of the same material as the rest of the mouth guard or in the alternative the hinge means are made of a different material than the rest of the mouth guard. For example, the hinge means can be made of rubber, plastic, flexible material, man-made material, and or stainless steel hinges. The hinge means allows the single unit to open and close like the dentures of the user making it more comfortable than the conventional bulky mouth guard on the market today.

FIG. 2 shows a side view of the mouth guard (100) of the present invention. The mouth guard (100) has an upper portion (105) and a lower portion (110). The upper and lower portions are connected together at a left hinge means (not shown) and a right hinge means (140). The hinge means connect the upper and lower portion into one unit and allow the mouth guard to operate as actual dentures of the user. The upper portion (105) and the lower portion (110) both have flavor pockets (125) for flavor capsules. As described above the flavor capsules are used to release flavor into the oral cavity of the user. In the alternative or in addition to the flavor capsule flavor can be directly impregnated into the material of the mouth guard. The flavor can also be in the form of flavor crystals. The flavor crystals are concentrated crystals of flavor that release slowly into the oral cavity when used.

As shown in FIG. 2, the lower and upper portions have an outer wall (120) and an inner wall (115) that creates an open area within the center of the mouth guard (135). This open area can be made as large as possible so as not to compromise the protecting aspect of the mouth guard but as to increase the area for gas exchange in the oral cavity. Increase gas exchange allows for the user to release more carbon dioxide and take in more oxygen during aerobic respiration. This added feature makes the mouth guard more comfortable and makes the user more oxygenated when exercising.

FIG. 3 shows a second embodiment of the invention, namely the mouth guard of FIG. 1 having cilia dispersed throughout. As shown in FIG. 3, the mouth guard of the instant invention (200) has an upper portion (205) that has an outer wall (215) and an inner wall (210) that is connected together by a base (220). The outer wall (215) is high enough to protect the front teeth of the user, yet low enough not to irritate the gums of the user. The inner wall (210) may be lower than the outer wall (215) so that the user's tongue can comfortably rest behind the inner wall (210). The outer and inner walls can be sloped so as to be higher in towards the front of the teeth and slope downward towards the back of the mouth guard.

Dispersed throughout a channel formed by the inner wall (210), the outer wall (215) and base (220) are filamentous extensions that are anchored to the base and extend away from the base. These filamentous extensions are referred to as cilia (275) for the purpose of this patent. The cilia (275) can be spaced evenly throughout or bunched in particular areas as per the design of each mouth guard. The cilia (275) provide a source of resistance between the teeth and inner wall (210), base (220) and outer wall (215) to assure a snug fit. Once the mouth guard is placed on the teeth of the user, the cilia (275) are depressed and deflected so as to tightly fit around the user's teeth. As is understood in the art, a tight fit is necessary for proper protection of the user's teeth. This proper fitting is accomplished without the use of any molding or hot water techniques.

As shown in FIGS. 1 and 2, the upper and lower portions are connected together by right hinge means (240) and left hinge means (235) so as to make a single unit. Once the mouth guard is in place the mouth guard protects the teeth from grinding and smashing together should the user be struck in the mouth area. The portion of the teeth having the mouth guard in place will also be protected from trauma and or breakage.

Also as shown in FIGS. 1 and 2, the upper and lower portions may be equipped with at least one flavor pocket (225, 265) is formed in either the inner wall or outer walls of the mouth guard. The flavor pockets (225, 265) are sized and shaped so as to accommodate a flavor containing capsule (not shown). The flavor containing capsule contains either a gel or fluid within and has a thin skin so that it easily bursts upon pressure being placed thereupon. Once the flavor capsule is inserted into the mouth guard and the mouth guard is in place, applying pressure either through the use of the tongue or by biting down flavor is released. The flavor can enter the oral cavity directly or through flavor passages (not shown).

The flavor passages can be as simple as an opening in the inner walls of the mouth guard or can include accurate channels that extend between the flavor pocket and the inner surface of the inner wall so as to allow the flavor to flow from the flavor pocket to the oral cavity once the flavor capsule is ruptured. The flavor passages can be slightly accurate or arched so as to form a vertical incline which will regulate the flow of gel flowing from the flavor capsule contained in the flavor pocket through the arched channels and into the mouth of the user. Having this incline the user is able to take advantage of the flavor through an extended period of time over the course of a game and/or practice, rather than having the flavor from the capsules flow into his mouth quite readily and the taste be experienced only for a short time.

The flavor pocket may be fitted with an upper opening or slit in the rubberized material of the mouth guard which makes up the mouthpiece. The slit may be a flexible slit and would allow the user to slide the flavor gel capsule through the slit and into the flavor pocket. Once in place, the slit would then return back to its closed position, and therefore, would prevent the capsule from sliding out of the pocket inadvertently. This is important so as to prevent a choking hazard should the flavor capsule become dislodged due to blunt trauma.

In an alternative embodiment of the invention, the flavoring can also be impregnated into the mouth guard material so as to provide all of the flavor or in addition of the flavor capsules. The mouth guard may also have flavor crystals lodged within the mouth guard so as to release flavor over time. Again this can be in addition to the flavor provided by the flavor capsules or the sole source of flavoring for the mouth guard.

The mouth guards of the present invention may be molded out of resilient materials such as rubber, plastic, polymers, as well as other man-made materials. The cilia of the mouthguards must be mandible so that they can be depressed, and maneuvered so as to allow the teeth to fit into the channel with a tight fit. The molding and/or casting of the mouthguards described herein may be made using molding techniques that are well know in the art. The material used may be impregnated with flavor or antibacterial agents that keep the mouth guard smelling and tasting fresh while preventing bacterial growth in between uses. The techniques used to impregnate additives during the molding process are also well know in the art and can be used to make the mouthguards of the present invention.

While the invention has been illustrated and described with respect to specific illustrative embodiments and modes of practice, it will be apparent to those skilled in the art that various modifications and improvements may be made without departing from the scope and spirit of the invention. Accordingly, the invention is not to be limited by the illustrative embodiments and modes of practice.

What is claimed is:

1. A mouth guard comprising:
an upper U-shaped portion having an inner wall and outer wall, said inner and outer walls connected to each other by a base forming a channel between said inner and outer walls;
a lower U-shaped portion having an inner wall and outer wall, said inner and outer walls connected to each other by a base forming a channel between said inner and outer walls said upper U-shaped portion connected to said lower U-shaped by two points located at the back of each of said upper and lower portions.

2. The mouth guard according to claim 1 further comprising a flavoring material.

3. The mouth guard according to claim 3 wherein said flavoring material is impregnated within the material from which said mouth guard is constructed.

4. The mouth guard according to claim 4 wherein said flavoring material that is impregnated within the material from which said mouth guard is constructed is in the form of flavor crystals.

5. The mouth guard according to claim 1 further comprising a least one pocket formed in at least one of said inner walls, outer walls or said base, said pocket sized and shaped to receive a flavoring agent capsule; and
at least one duct extending from said pocket to an inner surface of said mouth guard whereby defining a passageway for said flavoring agent to flow from said pocket containing said flavoring agent to the mouth of the user when sufficient force is placed on said flavoring agent capsule by the user.

6. The mouth guard according to claim 1 further comprising an opening formed in said pockets, whereby providing a passageway for said flavoring agent capsule to be replaced.

7. A mouth guard comprising:
a first U-shaped structure having an inner wall and outer wall, said inner and outer walls connected to each other by a base forming a channel between said inner and outer walls designed for the upper teeth of a user;
a second U-shaped structure having an inner wall and outer wall, said inner and outer walls connected to each other by a base forming a channel between said inner and outer walls designed for the lower teeth of a user;
said first U-shaped structure being connected to said second U-shaped structure so that the channel of the first U-shaped structure fits on the user's upper teeth while the second U-shaped structure fits on the user's lower teeth and the mouth guard is removed from the user's mouth as a single unit; and
a plurality of flexible extensions projecting away from said base within said channel of said first U-shaped structure and said second U-shaped structure whereby at least a portion of said plurality of flexible extensions are formable to the dentition of the user.

8. The mouth guard according to claim 8 wherein said plurality of flexible extensions comprises at least one elastomeric material.

9. The mouth guard according to claim 9 further comprising a flavoring material.

10. The mouth guard according to claim 9 wherein said flavoring material is impregnated within the material from which said mouth guard is constructed.

11. The mouth guard according to claim 11 wherein said flavoring material that is impregnated within the material from which said mouth guard is constructed is in the form of flavor crystals.

12. The mouth guard according to claim 8 further comprising a least one pocket formed in at least one of said inner walls, outer walls or said base, said pocket sized and shaped to receive a flavoring agent capsule; and
at least one duct extending from said pocket to an inner surface of said mouth guard whereby defining a passageway for said flavoring agent to flow from said pocket containing said flavoring agent to the mouth of the user when sufficient force is placed on said flavoring agent capsule by the user.

13. The mouth guard according to claim 8 further comprising an opening formed in said pockets, whereby providing a passageway for said flavoring agent capsule to be replaced.

14. The mouth guard according to claim 8 further comprising a tether attached to said mouth guard whereby providing for a quick way to remove said mouth guard from a user's mouth.

15. The mouth guard according to claim 10 wherein the flavoring agent is selected from the group consisting of mint flavoring, sweet flavoring, vanilla flavoring, bubblegum flavoring, sour flavoring, electrolyte containing flavoring, caffeine containing flavoring and cola flavoring.
